(19) United States
(12) Patent Application Publication
(10) Pub. No.: US 2015/0203053 A1
(43) Pub. Date: Jul. 23, 2015

(54) SHELF

(71) Applicant: Anders Carlsson, Hisings Backa (SE)

(72) Inventor: Anders Carlsson, Hisings Backa (SE)

(73) Assignee: MODUL-SYSTEM HH AB, Molndal (SE)

(21) Appl. No.: 14/411,016

(22) PCT Filed: Jul. 3, 2012
(86) PCT No.: PCT/EP2012/062905

§ 371 Date: Jan. 21, 2015

(51) Int. Cl. B60R 11/06; A47B 96/02

(52) U.S. Cl. CPC B60R 11/06; A47B 96/021; A47B 96/024

(57) ABSTRACT

The invention discloses a shelf system in a service vehicle (1) comprising a base (11) for arranging articles thereon and a first side wall (13a), wherein said first side wall (13a) comprises a first wall portion (21) connected to the base (11) and a second wall portion (22), wherein said first wall portion (21) continues into said second wall portion (22) and said second wall portion (22) overlaps at least partly said first wall portion (21) in such a way that said first and second wall portions (21, 22) form a channel (23) along the longitudinal direction of the first side wall, and said second wall portion (22) is at least in some locations connected to said first wall portion (21) along the longitudinal direction of the first side wall (21) so that said channel (23) is at least partly a closed channel (23) in the longitudinal direction of the first side wall (21).

### FIELD OF THE INVENTION

The present invention relates to a shelf for a shelf system in a service vehicle comprising a base for arranging articles thereon and a first side wall.

### TECHNICAL BACKGROUND

Service vehicles are used for a wide range of areas and the cargo space may be equipped to suit a particular application. For instance, a service vehicle may be used for storage and transport of tools for different kinds of craftsmen. It is common practise to equip the cargo space of a service vehicle with for instance storage cabinets, tool holders, shelves or other module units.

Within the vehicle industry it is always a desire to reduce the weight of a vehicle and the interior within it. Normally, shelves in service vehicles are made of relatively thick metal, such as aluminium or steel, in order to be able to carry a lot of weight. Thus, these shelves are often quite heavy and also expensive due to the amount of material. Hence, there is a need for an improved shelf adapted for cargo spaces of service vehicles, which preferably is of less weight, but at the same time should be able to carry the same amount of weight as a known shelf.

### SUMMARY OF THE INVENTION

The object of the present invention is to provide a shelf that overcomes the above issues. According to a first aspect of the invention this is accomplished by a shelf for a shelf system in a service vehicle comprising a base for arranging articles thereon and a first side wall, wherein said first side wall comprises a first wall portion connected to the base and a second wall portion, wherein said first wall portion continues into said second wall portion and said second wall portion overlaps at least partly said first wall portion in such a way that said first and second wall portions form a channel along the longitudinal direction of the first side wall, and said second wall portion is at least in some locations connected to said first wall portion along the longitudinal direction of the first side wall so that said channel is at least partly a closed channel in the longitudinal direction of the first side wall. If a side wall has at least a partly closed channel-structure, it will make the side wall more stable, which will make the shelf more durable. For example if the base of the shelf is relatively thin, the base will tend to buckle at the place where a heavy article is arranged due to the heavy load and this deformation/force will also apply to the side wall which will tend to bend towards the centre of shelf. The closed channel-structure will prevent that the side wall deforms towards the centre of the shelf. This reinforced side wall makes it possible to use a thinner sheet metal for making the shelf. The shelf may then weigh less. For example, a shelf may be made by a high-strength steel, for example ultra high strength steel, and by having the shape on the side wall described above the sheet for making the shelf may, for example be 0.6 mm thick instead of 1.2 mm. The geometry of the side wall reinforces the material and makes it stronger.

The shelf may be arrangable to a module system, module unit or a shelf system. These systems may be adapted to be used in a back space of a service vehicle.

According to at least one exemplary embodiment said channel is arranged at the upper part of said first side wall.

According to at least one exemplary embodiment a sub-portion of said second wall portion is extending essential parallel to said first wall portion in a direction towards the base and abutting said first wall portion, and said second wall portion is connected to said first wall portion in the area of said sub-portion of said second wall portion. A sub-portion gives an extra area where it is possible to create a connection between the first and the second wall portions.

According to at least one exemplary embodiment said second wall portion is connected to said first wall portion by mechanical fasteners at said locations. According to at least one exemplary embodiment said mechanical fasteners are rivets and/or screws.

According to at least one exemplary embodiment said second wall portion is connected to said first wall portion by welding or clinching. When using welding the parts can be connected to each other by spot welding or seam welding. By using clinching no extra fasteners are necessary. The two wall portions will form a kind of rivet by itself.

According to at least one exemplary embodiment said channel has a rectangular cross-section. It may, however, have any suitable shape.

According to at least one exemplary embodiment said first side wall has a longitudinal extension along the longitudinal direction of the shelf. If the shelf is a very long shelf, having a longitudinal direction, it is preferable that the reinforced wall has its extension along the longitudinal direction of the shelf since this side wall will easier collapse than a side wall which is arranged on a side which is perpendicular to the longitudinal direction of a shelf.

According to at least one exemplary embodiment said shelf comprises four sides with a first pair of opposite sides and a second pair of opposite sides, wherein said first side wall is arranged on one of the sides of said first pair of opposite sides and a second side wall is arranged on the second side of said pair first pair of opposite sides and said second side wall has the same design as said first side wall.

According to at least one exemplary embodiment said shelf comprises four sides with a first pair of opposite sides and a second pair of opposite sides, wherein said first side wall is arranged on one of the sides of said first pair of opposite sides and a second side wall is arranged on the second side of said first pair of opposite sides and said second side wall has the same design as said first side wall but mirror inverted. By having a second side wall on the opposite side of the shelf, which has the same design as the first side wall but mirror inverted the shelf will have the same look from both sides. The shelf can then be mounted with either side wall showing towards the user, and the shelf system will always look the same.

According to at least one exemplary embodiment said shelf comprises four sides with a first pair of opposite sides and a second pair of opposite sides, wherein said first side wall is arranged on one of the sides of said first pair of opposite sides and said base comprises a base reinforcement on the second side of said first pair of opposite sides, wherein said base continues into a base portion, said base portion overlaps at least partly said base in such a way that said base portion and said base forms a channel parallel to the longitudinal direction of said first side wall, and said base portion is at least in some locations connected to said base along the longitudinal direction of the first side wall so that said channel is at least partly a closed channel parallel to longitudinal direction of the first side wall. If one side of the shelf shall be open in order to make it easier to reach articles arranged therein the shelf is preferable reinforced this way. The reinforced base side will prevent the base to deform when a heavy article is arranged on the thin base. The base reinforcement may be on the underside of said base, then it will not be in the way. The base portion may be connected to the base in the same way as described above in regard to the first wall portion and the second wall portion, i.e. by rivets, screws, welding or clinching.

According to at least one exemplary embodiment said second pair of opposite sides are arranged perpendicular to said first pair of opposite sides wherein a third side wall is arranged on one of the sides of said second pair of opposite sides and/or a fourth side wall is arranged on the other one of the sides of said second pair of opposite sides. By having a third and/or a fourth side wall the shelf gets sturdier. This, since each side wall reinforces the base of the shelf.

According to at least one exemplary embodiment said shelf comprises four sides with a first pair of opposite sides and a second pair of opposite sides, wherein said first side wall is arranged on one of the sides of said first pair of opposite sides and a third side wall is arranged on one of the sides of said second pair of opposite sides and/or a fourth side wall is arranged on the other one of the sides of said second pair of opposite sides.

According to at least one exemplary embodiment a corner clip is arranged to the first side wall and to the third and/or fourth side walls in order to connect the corner of the shelf. A corner clip connects two sidewalls together and reinforces the corner of the shelf.

According to at least one exemplary embodiment said first side wall is connected to the third side wall and/or to the fourth side wall. The first side wall may be connected to the third side wall and/or the fourth side walls by spot welding, clinching etc.

According to at least one exemplary embodiment said shelf is made of a high-strength material, for example ultra high strength steel. With these materials the Young's modulus (modulus of elasticity) is the limited factor, however the shelf is improved by the shape of the shelf i.e. the side wall/side walls of the shelf, with its partly closed channel and/or the base reinforcement discussed above.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and nonlimiting detailed description of preferred embodiments of the present invention, with reference to the appended drawings, where the same reference numerals will be used for similar elements, wherein:

FIG. 1 discloses an open-up perspective view of a service vehicle comprising a module unit with a shelf according to the invention.

FIG. 2 discloses a perspective view of a shelf according to a first embodiment of the invention.

FIG. 3 discloses an exploded view of FIG. 2 with one side wall not bent.

FIGS. 4a, 4b, 4c, 4d, 4e, 4g disclose different variants of the cross-section A-A of the side wall in FIG. 3.

FIG. 5 shows a part of FIG. 2 with one corner clip of a first embodiment exploded from the shelf.

FIG. 6 shows a second embodiment of a corner clip.

FIG. 7 shows a third embodiment of a corner clip.

FIG. 8 shows a shelf similar to FIG. 1 with the side walls according to FIG. 4b with the corners connected to each other.

FIG. 9 shows a shelf according to a second embodiment of the invention with only one side wall.

FIG. 10 shows the cross-section B-B of FIG. 9.

### DETAILED DESCRIPTION OF PREFERRED EMBODIMENTS

Currently preferred embodiments of the present invention will now be described in more detail, with reference to the accompanying drawings.

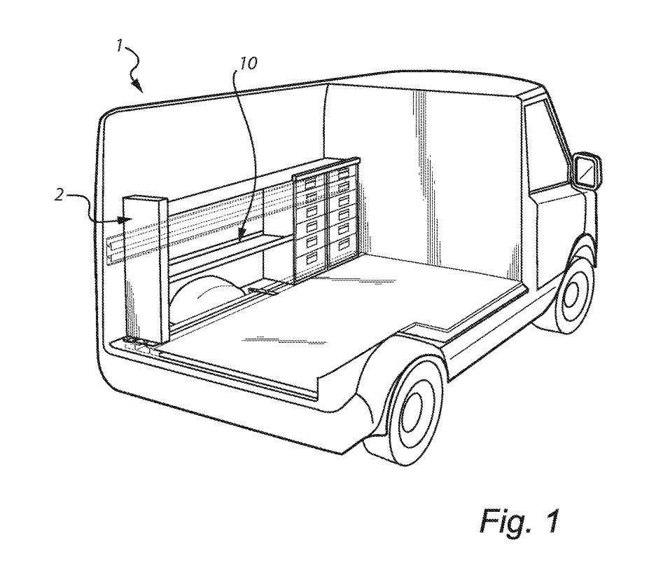

FIG. 1 shows a service vehicle 1 with a module unit 2 comprising a shelf 10. The shelf is arranged in the module unit and connected to the module unit by fasteners, for example screws (not shown).

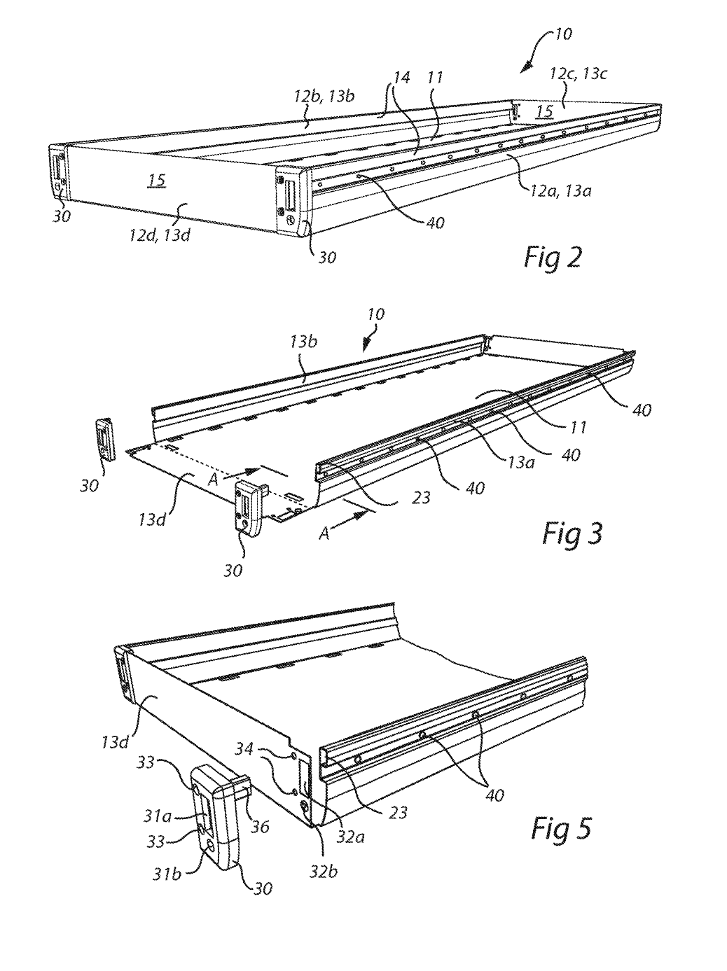

FIG. 2 shows a shelf 10, which is extending in a longitudinal direction. The shelf comprises a base 11. The base 11 has four sides 12a, 12b, 12c, 12d with a first pair of opposite sides 14 extending in the longitudinal direction of the shelf 10 and a second pair of opposite sides 15 which are arranged perpendicular to the first pair of opposite sides 14. On each side of said first pair of opposite sides 14 is a first side wall 13a and a second side wall 13b arranged. On each side of said second pair of opposite sides 15 is a third side wall 13c and a fourth side wall 13d arranged. The side walls 13a, 13b, 13c, 13d are made in one piece with the base 11 by bending the side walls 13a, 13b, 13c, 13d to a desired position. The corners of the shelf are connected by corner clips 30.

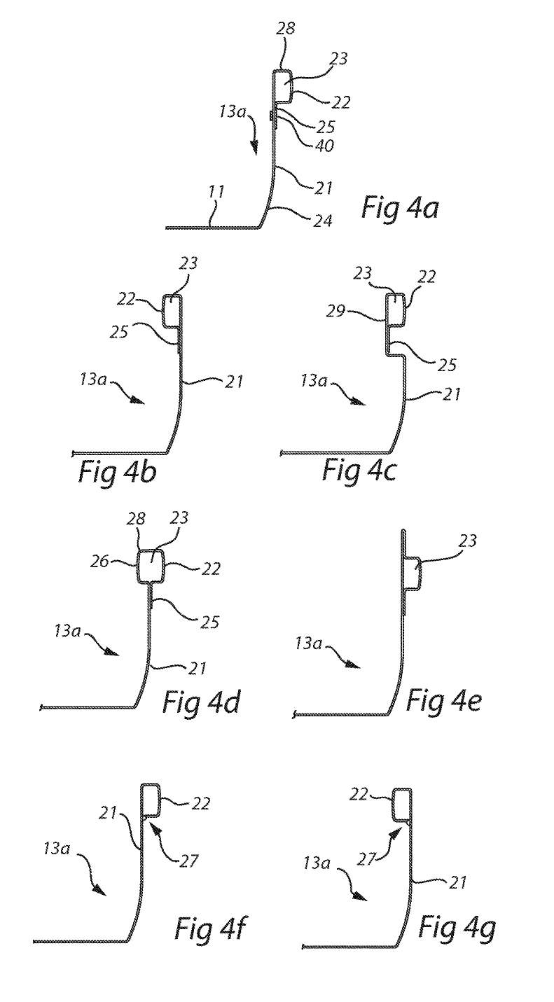

FIG. 3 shows the shelf 10 in FIG. 2 but with the fourth side wall 13d unbent, i.e. when it is in the same plane as the base 11 of the shelf 10 and with the corner clips 30 removed. The first and the second side walls 13a and 13b, which are extending in the longitudinal direction of the shelf 10, have the same shape, however they are mirror inverted. Hence, only the first side wall 13a will hereinafter be described. The first side wall 13a is so designed that it has a closed or at least a partly closed structure on its top portion, which creates a channel 23 in the longitudinal direction of the shelf 10. The channel 23 is created by the side wall 13a being bent into a suitable channel shape. Here the channel 23 is exemplified by a rectangular shape, however it may take any suitable shape, for example some of the walls of the channel may be in an angle to the other walls which are larger or smaller than 90°. The channel 23 is in at least some locations in the longitudinal direction of the side wall a closed channel. The channel 23 is, as here exemplified, closed by using rivets 40. The rivets 40 are arranged at equal distances from each other over the whole length of the shelf. The channel 23 is not limited to being closed by using rivets and they do not have to be arranged at equal distances. Further alternatives are discussed in regard to FIG. 4a and FIGS. 4f and 4g.

FIG. 4a shows one exemplary embodiment of the cross-section of the first side wall 13a at cross-section A-A in FIG. 3. The cross-section shown in FIG. 3 will be discussed in regard to FIG. 4c. The first side wall 13a in FIG. 4a comprises a first wall portion 21 and a second wall portion 22. The first wall portion 21 is connected to the base 11 and it is extending perpendicular to the base 11 via a curved portion 24. The first wall portion 21 is not limited to be perpendicular to the base 11 and to have a curved portion 24. It may be in an angle to the base 11. Further the first wall portion 21 may be curved.

The first wall portion 21 continues into the second wall portion 22. This can be done via a transition portion 28, which is exemplified as perpendicular to said first wall portion 21. The second wall portion 22 overlaps partly the first wall portion 21 on the outside of shelf 10 in such a way that the first and the second wall portions 21, 22 form a loop 23, i.e. a channel 23 in the longitudinal direction of the first side wall 13a. The loop 23 has a rectangular shape and is directed towards the outside of the shelf. That is, the channel 23 has a rectangular shaped cross section. Hence, the first side wall 13a has a P-shaped top portion, which is protruding over the outer contour of the shelf. However, the channel 23 is not limited to have a rectangular shaped cross-section, it may have any suitable shape. It may for example be circular or semi-circular. A sub-portion 25 of the second wall portion 22 is extending essential parallel to the first wall portion in a direction towards the base 11 and it is abutting the first wall portion 21. The second wall portion 22 is connected to the first wall portion 21 in the area of the sub-portion 25 of the second wall portion 22 by clinching the two metal parts together so that one kind of rivet 40 is formed. Several connections are arranged in this area along the longitudinal direction of the first wall. Alternatively rivets, screws and nuts, or sheet metal screws could be used to connect the two wall portions 21, 22 together. They could also be spot welded or welded over a distance or over the whole length of the first side wall 13a.

FIG. 4b shows a similar design of the first side wall 13a as the one described with regard to FIG. 4a, with the differences that the second wall portion 22 is overlapping the first wall portion 21 on the inside of the self, so that the loop, i.e. the channel 23 is on the inside of the shelf. That is the P-shaped top portion is pointing in the opposite direction, i.e. it has a mirror inverted P-shape to the one shown in FIG. 4a. The second wall portion 22 also has a similar sub-portion 25 as described above, however arranged on the inside of the shelf and it can be connected to the first wall portion 21 in a similar way as described above.

FIG. 4c shows the cross-section at A-A in FIG. 3 of the first side wall 13a. The shape of the cross-section is almost the same as the one described in regard to FIG. 4a, except that the whole overlapping second wall portion 22, including the sub-portion 25, and a sub-portion 29 of the first wall portion 21 which is being overlapped by the second wall portion 22 is projecting into the shelf. Hence, the first side wall 13a has a step shaped shape. This way the outer contour of the top portion of the first wall 13a follows the outer contour of the shelf, i.e. the P-shaped top portion is not protruding outside the outer contour of the shelf. That is the first wall portion 21. The second wall portion 22 also has a similar sub-portion 25 as described above and it can be connected to the first wall portion 21 in a similar way as described above

FIG. 4d shows another exemplary embodiment where the loop 23, i.e. the channel 23 is centrally arranged over the first side wall 13a. The first wall portion 21 has a step shaped top portion 26 which continues into the second wall portion 22 via a transition portion 28 and the second wall portion 22 overlaps partly the first wall portion 21 in such a way that the step shaped top portion 26 and the second wall portion 22 forms the loop 23, i.e. the channel 23 in the longitudinal direction of the first side wall 13a. The loop 23 has a rectangular shape and is directed towards both the outside and the inside of the shelf. The loop/channel 3 may however have a different shape than rectangular. The second wall portion 22 also has a similar sub-portion 25 as described above and it can be connected to the first wall portion 21 in a similar way as described above.

FIG. 4e has a similar shape as the side wall 13a in FIG. 4a, except that the loop 23, i.e. the channel is not right on the top of the first wall 13a. The loop, i.e. the channel 23 is positioned at a distance from the top.

FIG. 4f shows the first side wall 13a, similar to FIG. 4a but without a sub-portion (sub-portion 25 in FIG. 4a) on the second wall portion 22. Instead the second wall portion 22 is directly welded 27 to the first wall portion 21 and it ends perpendicular to the first wall portion 21.

FIG. 4g shows the first side wall 13a, similar to FIG. 4f, with the second side portion 22 welded to the first portion 21, but mirror inverted.

In FIG. 2 and FIG. 3 both the first side wall 13a and the second side wall 13b are the same, however mirror inverted. They may, however, differ. For example the first side wall 13a may have a side wall as described in regard to FIG. 4a and the second side wall 13b may have a side wall as described in regard to for example FIG. 4d.

The third and the fourth side walls 13c and 13d in FIG. 2, which are extending perpendicular to the longitudinal direction of the shelf 10 are each a one portion wall which is here extending perpendicular to the base 11 of the sheet. In the area where the end clip 30 shall be positioned, openings are provided which correspond to connecting parts of the corner clips.

In FIG. 5 one corner clip 30 is removed. The corner clip 30 has an approximately rectangular shape which is adapted to follow the outer contour of the shelf. It has a protruding connecting portion 36, which has an outer contour which follows the inner contour of the loop 23, i.e. the inner contour of the channel 23, however it is slightly smaller so that it fits into the loop/channel 23. The clip 30 has a larger rectangular 31a and a smaller shelf mounting opening 31b. The fourth sidewall 13d has on each respective side a larger rectangular 32a and a smaller shelf mounting opening 32b which each will be in register with the larger rectangular 31a and the smaller shelf mounting opening 31b of a respective corner clip 30 when the clip 30 is arranged to the corners of the shelf. These openings can be used to arrange the shelf to a side unit or to a module unit. Through the holes 33, 34 in the corner clip and the shelf the clip can be fastened to the shelf, for example by screws. This corner clip if preferably made of plastic, may however be of other suitable materials.

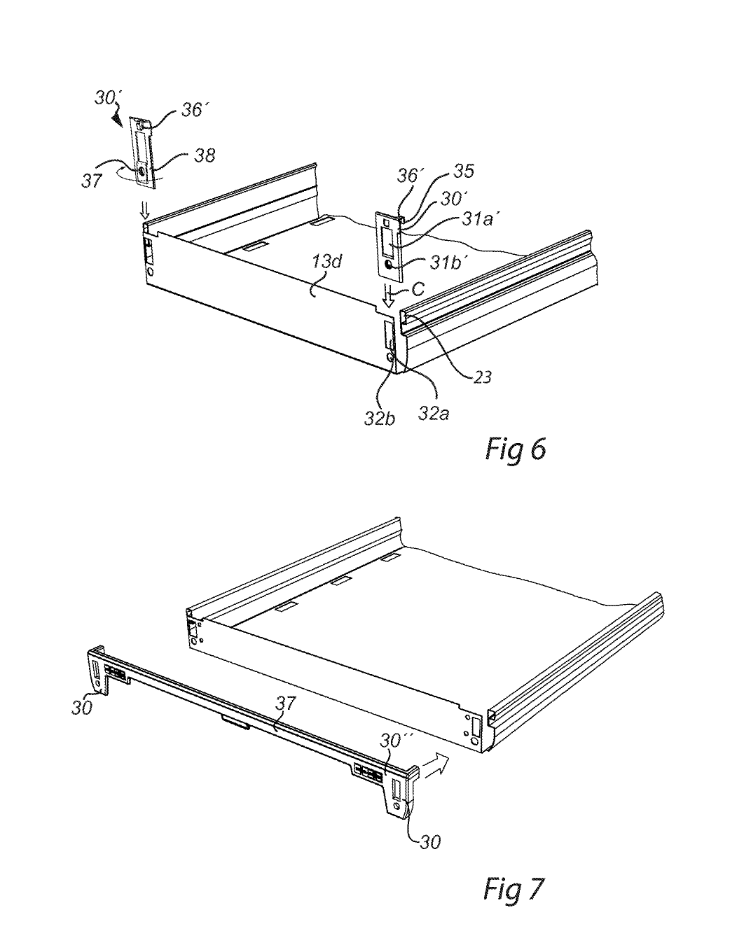

FIG. 6 shows another corner clip 30′. This is a sheet metal corner clip 30′. The corner clip 30′ has an approximately rectangular shape which is adapted to follow the outer contour of the shelf. It has a protruding connecting portion 36′ with a tab 35 on the side facing the inner side of the shelf when arranged to the shelf. The protruding connecting portion 36′ and its tab 35 will connect to the channel 23. The tab 35 will protrude into a hole (not shown) on the top of the channel. The clip 30′ has a larger rectangular 31a′ and a smaller shelf mounting opening 31b′. The fourth sidewall 13d has on each respective side a larger rectangular 32a and a smaller shelf mounting opening 32b, similar to the one shown in FIG. 5, which each will be in register with the larger rectangular 31a′ and the smaller shelf mounting opening 31b′ of the corner clip 30′ when the corner clip 30′ is arranged to the corners of the shelf. These openings can be used to arrange the shelf to a side unit. The larger rectangular shelf mounting opening 31a′ has a tongue 38 which is bent from the material in the clip towards the side facing the inner side of the shelf when arranged to the shelf. The corner clip 31′ will be attached on the shelf by being pushed onto the side wall 13d from above, see arrow C. The tongue 38 will pass through the larger rectangular mounting opening 32a and will overlap part of the third side wall 13d on the inside of the shelf. The tongue 38 also has an opening 37 which will be in register with the smaller shelf mounting opening 31b when arranged in a correct position on the side wall 13d.

FIG. 7 shows a corner clip 30″ which will connect two corners to each other. The corner clip 30″ comprises of two corner clips 30 as described in regard to FIG. 5, and will hence not be further described, and they are connected by a connecting part 37 which connects the two corner clips 30 into a single corner clip 30″. The corner clip 30″ is preferably made of plastic and made in one piece. The connected corner clip 30″ and shelf 10 may also have the holes 33, 34 shown in FIG. 5 but not shown in FIG. 7. If it has the holes the corner clip can be fastened to the shelf, for example by screws.

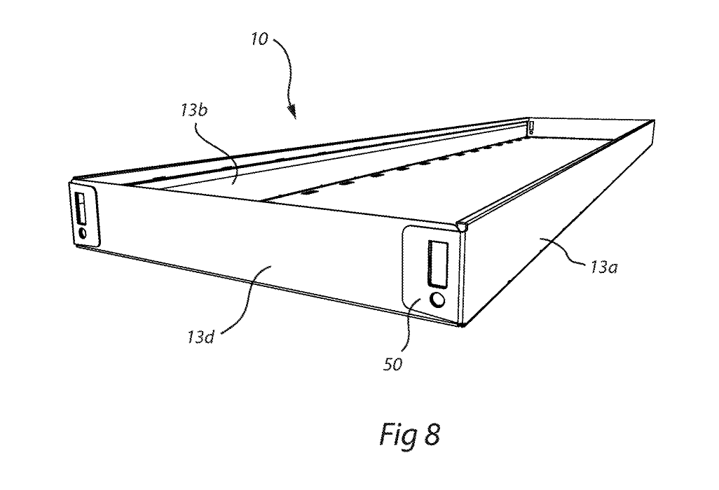

FIG. 8 shows a shelf 10 without corner clips. Here the first side wall 13a and the fourth side wall 13d are connected to each other by a portion 50 of the first side wall 13a, which is being bent so that it overlaps the fourth side wall 13d and they are connected by, for example, spot welding, However they can be riveted or clinched or attached in any suitable way. All corners are connected this way. Alternatively, the fourth side wall 13d may comprise a portion which is bent so that it overlaps the first side wall 13a and they may then be attached together.

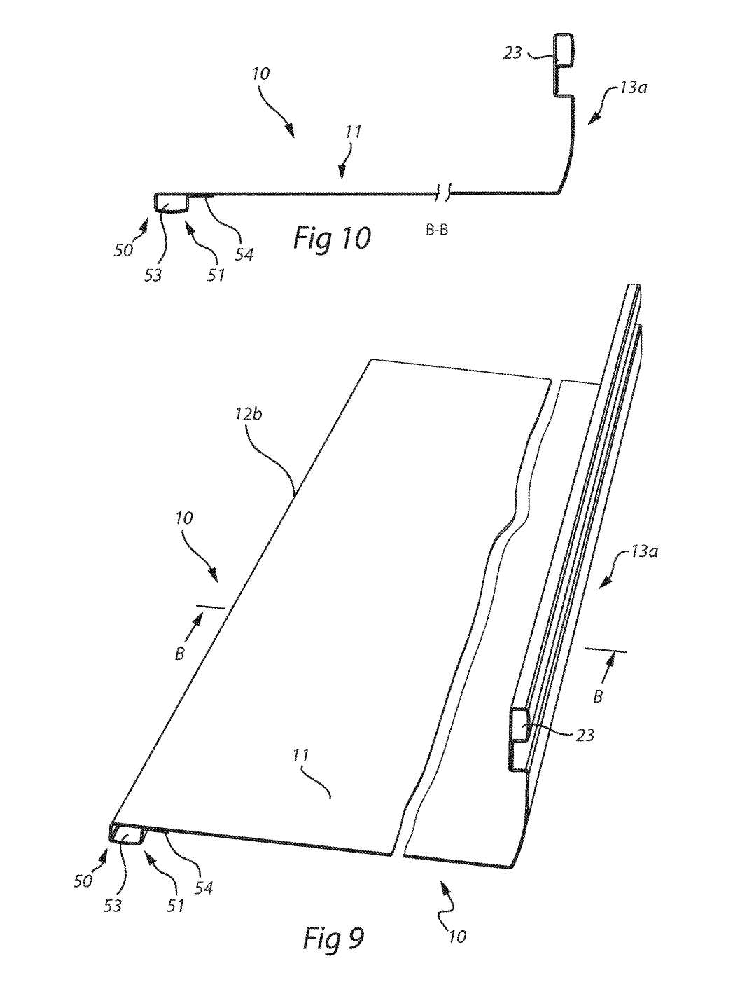

FIG. 9 shows a second embodiment of the shelf 10. The shelf 10 has a similar design to the shelf as described in regard to FIG. 2. It has a first side wall 13a with its channel 23, i.e. a first channel. However at the second side 12b of the base there is no second side wall arranged and no third and fourth side walls are shown, however they may be there and the corners can be connected to each other by, for examples, corner clips. Instead of a second side wall the shelf is open and comprises a base reinforcement 50 on the second side 12b.

FIG. 10 shows the cross-section B-B with the base reinforcement 50 on one side. The base 11 continues into a base portion 51 (se also FIG. 9), which overlaps at least partly said base 11 on the underside in such a way that said base portion 51 and said base 11 forms a channel 53, i.e. a second channel, along the longitudinal direction of the first side wall 13a. The base portion 51 has a sub portion 54 which is abutting the underside of the base 11. The base portion 53 is at least in some positions at the area of the sub portion 54 connected to said base 11 along the longitudinal direction of the first side wall 13 so that the channel 53 is at least partly a closed channel 53 in the longitudinal direction of the first side wall 13a. The connection can be done in the same way as described for the first side wall 13a.

The channel 53 has a rectangular cross-section. However it is not limited to be rectangular, it may take any suitable shape, for example any one of the ones described in regard to the channel 23 of the first side wall 13a. The base portion 51 does not have to overlap on the underside of the base 11, it may overlap on the upper side.

The shelves described in regard to the FIGS. 1-10 are made of sheet metal which are being roll formed or bent.

The invention has mainly been described above with reference to a few embodiments. However, as is readily appreciated by a person skilled in the art, other embodiments than the ones disclosed above are equally possible within the scope of the invention, as defined by the appended patent claims.

1. A shelf for a shelf system in a service vehicle comprising a
base for arranging articles thereon and
a first side wall, wherein said first side wall comprises
a first wall portion connected to the base and a second wall portion, wherein said first wall portion continues into said second wall portion and
said second wall portion overlaps at least partly said first wall portion in such a way that said first and second wall portions form a channel along the longitudinal direction of the first side wall, and
said second wall portion is at least in some locations connected to said first wall portion along the longitudinal direction of the first side wall so that said channel is at least partly a closed channel in the longitudinal direction of the first side wall.

2. A shelf according to claim 1, wherein said channel is arranged at the upper part of said first side wall.

3. A shelf according to claim 1, wherein a sub-portion of said second wall portion is extending essentially parallel to said first wall portion in a direction towards the base and abutting said first wall portion, and said second wall portion is connected to said first wall portion in the area of said sub-portion of said second wall portion.

4. A shelf according to claim 1, wherein said second wall portion is connected to said first wall portion by mechanical fasteners at said locations.

5. A shelf according to claim 4, wherein said mechanical fasteners are rivets and/or screws.

6. A shelf according to claim 1, wherein said second wall portion is connected to said first wall portion by welding or clinching.

7. A shelf according to claim 1, wherein said channel has a rectangular cross-section.

8. A shelf according to claim 1, wherein said first side wall has a longitudinal extension along the longitudinal direction of the shelf.

9. A shelf according to claim 1, wherein said shelf comprises four sides with a first pair of opposite sides and a second pair of opposite sides, wherein said first side wall is arranged on one of the sides of said first pair of opposite sides and a second side wall is arranged on the second side of said first pair of opposite sides and said second side wall has the same design as said first side wall.

10. A shelf according to claim 9 wherein said second side wall is mirror inverted to said first side wall.

11. A shelf according to claim 1, wherein said shelf comprises four sides with a first pair of opposite sides and a second pair of opposite sides, wherein said first side wall is arranged on one of the sides of said first pair of opposite sides and said base comprises a base reinforcement on the second side of said pair first pair of opposite sides, wherein said base continues into a base portion,
said base portion overlaps at least partly said base in such a way that said base portion and said base forms a channel parallel to the longitudinal direction of said first side wall, and
said base portion is at least in some locations connected to said base along the longitudinal direction of the first side wall so that said channel is at least partly a closed channel parallel to longitudinal direction of the first side wall.

12. A shelf according to claim 1, wherein said shelf comprises four sides with a first pair of opposite sides and a second pair of opposite sides, wherein said first side wall is arranged on one of the sides of said first pair of opposite sides and a third side wall is arranged on one of the sides of said second pair of opposite sides and/or a fourth side wall is arranged on the other one of the sides of said second pair of opposite sides.

13. A shelf according to claim 9, wherein said second pair of opposite sides is arranged perpendicular to said first pair of opposite sides wherein a third side wall is arranged on one of the sides of said second pair of opposite sides and/or a fourth side wall is arranged on the other one of the sides of said second pair of opposite sides.

14. A shelf according to claim 12, wherein a corner clip is arranged to said first side wall and to at least one of said third or fourth side walls in order to connect the corner of the shelf.

15. A shelf according to claim 12, wherein said first side wall is connected to said third side wall and/or to said fourth side wall.

16. A shelf according to claim 1, wherein said shelf is made of a high-strength material, for example ultra high strength steel.
